(19) United States
(12) Patent Application Publication
(10) Pub. No.: US 2014/0167401 A1
(43) Pub. Date: Jun. 19, 2014

(54) CONTAINER SECURITY DEVICE

(71) Applicant: Michael Flynn, rancho santa fe, CA (US)

(72) Inventor: Michael Flynn, rancho santa fe, CA (US)

(21) Appl. No.: 13/716,095

(22) Filed: Dec. 15, 2012

(51) Int. Cl. B42D 15/00

(52) U.S. Cl. CPC B42D 15/00
USPC 283/81

(57) ABSTRACT

A simple and effective device is provided for securing containers from unwanted access. The device is particularly suited for preventing or detecting unwanted access of alcoholic and pharmaceutical containers. The device comprises an adhesive top portion, an elongated bridge portion, and an adhesive bottom portion. The top portion is affixed to the top of a container cap, and the bottom portion is affixed to the side of the container. In an exemplary embodiment, the top portion is circular and the bottom portion is rectangular. The adhesive portions have an embedded pattern or image that is visibly damaged if the adhesive portion is removed from the container surface, such that tampering is readily evident. The container lid or cap cannot be removed without breaking the seal on one or more of the adhesive portions and thus damaging the void pattern.

### RELATED U.S. APPLICATION DATA

This application claims priority to Provisional application No. 61/576,957, filed Dec. 16, 2011.

### FIELD OF THE INVENTION

The present invention relates to security devices for preventing unwanted access to various containers.

### BACKGROUND OF THE INVENTION

It is often desired to secure containers to prevent or detect unwanted access. A particular need exists to secure alcoholic beverage and pharmaceutical drug containers from unwanted tampering and consumption. For example, many households have alcohol beverages and parents are concerned about consumption of by minor children, particularly when unattended given that minors may attempt to consume alcoholic beverages in the house when unsupervised. For most households, it is impractical or impossible to secure or hide alcoholic beverages to prevent access by minors. Moreover, it can be difficult to monitor the content level of multiple alcoholic beverage bottles and parents often neglect to properly monitor such levels. There is a need for a simple and inexpensive way to detect and thus discourage unwanted tampering of alcoholic beverages. The same need holds true for pharmaceutical drug containers and other containers with sensitive contents that need to be protected.

The present invention provides an easy, inexpensive yet effective means of securing alcoholic beverages to discourage and detect unwanted tampering.

### SUMMARY OF THE INVENTION

A simple and effective device is provided for securing containers from unwanted access. The device is particularly suited for preventing or detecting unwanted access of alcoholic and pharmaceutical containers. The device comprises an adhesive top portion, an elongated bridge portion, and an adhesive bottom portion. The top portion is affixed to the top of a container cap, and the bottom portion is affixed to the side of the container. In an exemplary embodiment, the top portion is circular and the bottom portion is rectangular. The adhesive portions have an embedded pattern or image that is visibly damaged if the adhesive portion is removed from the container surface, such that tampering is readily evident. The container lid or cap cannot be removed without breaking the seal on one or more of the adhesive portions and thus damaging the void pattern.

### BRIEF DESCRIPTION OF THE DRAWINGS

FIG. 1 illustrates an embodiment of the container security device of the present invention.

FIG. 2 illustrates the security tape of the present invention being applied to a bottle.

### DETAILED DESCRIPTION

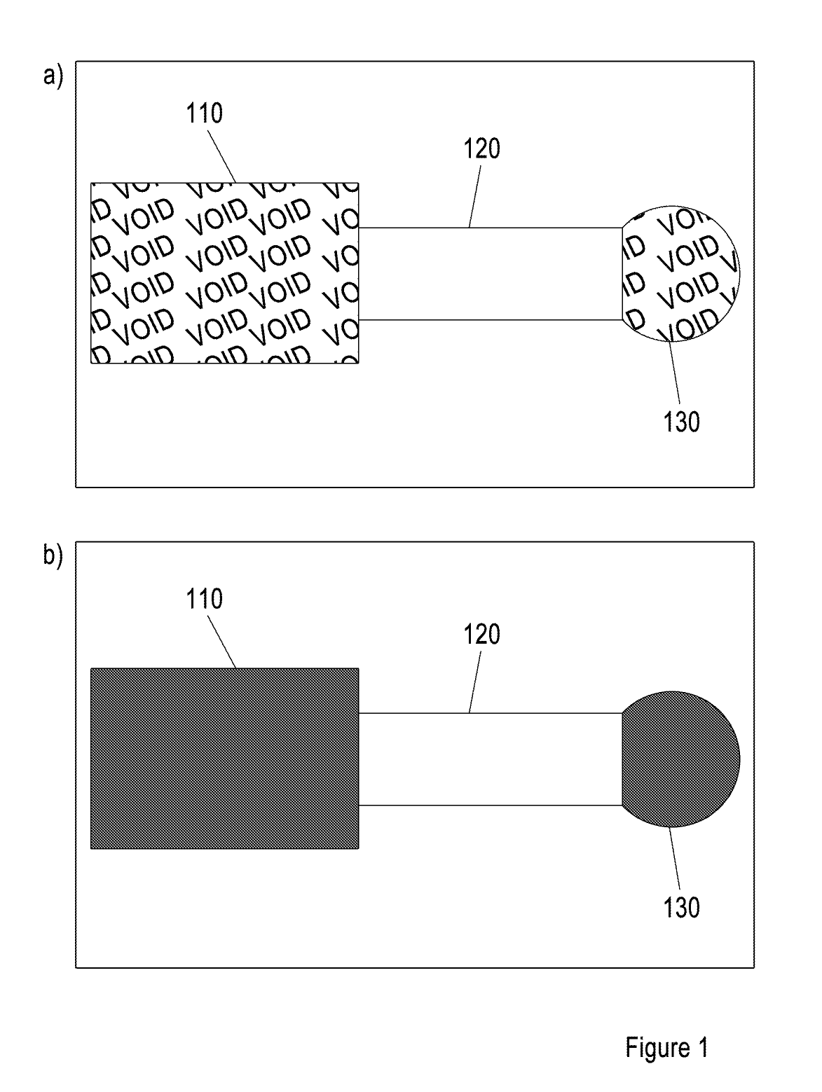

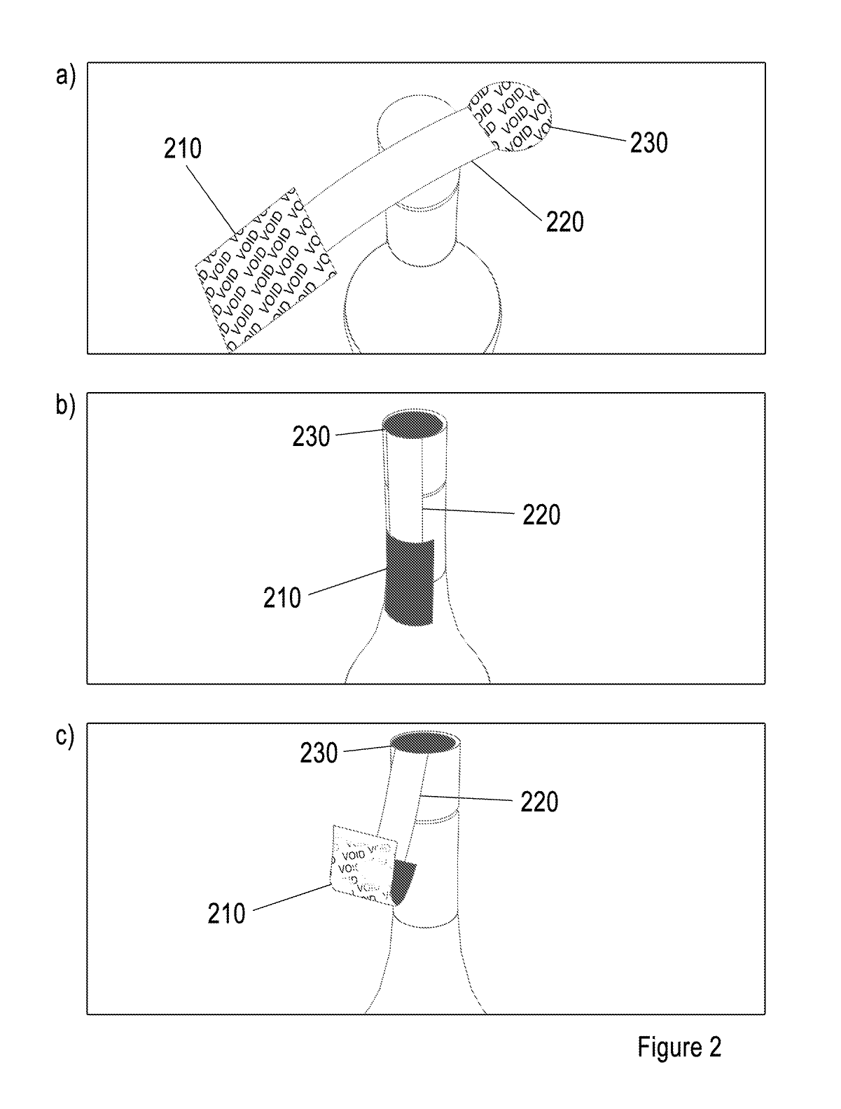

FIG. 1 illustrates bottom (FIG. 1a) and top (FIG. 1a) views of an exemplary embodiment of the present invention. The container security device is particularly suited for preventing or detecting unwanted access of alcoholic and pharmaceutical containers (i.e. bottled spirits and prescription drug containers). In an exemplary embodiment, the device comprises an adhesive circular top portion 130, an elongated bridge portion 120, and an adhesive rectangular bottom portion 110. The adhesive top and bottom portions include a “void” pattern that is embedded in the adhesive side as shown in FIG. 2a. The adhesive portions are covered by a thin plastic or paper cover that is removed prior to application, as commonly found on devices with adhesive or sticker surfaces. The void pattern may constitute a repeating text pattern as shown in FIG. 1, or an image, as long as it is readily apparent if a portion of the image or pattern is absent or faded. The top end portion 130 is affixed to the top of the container cap or lid, and the bottom portion is affixed to the side of the container, as shown in FIG. 2. The void pattern is configured such that it is damaged when the adhesive portion is removed from a surface, i.e. the side of the bottle or the top of the bottle cap. Thus, tampering is readily evident by the damaged void pattern. Moreover, the nature of the adhesive bond between the device and the container is such that once the bond is broken, it cannot be re-applied without the tampering being visibly apparent by the lack of adhesion and/or deformation of the top of bottom portion of the device. The device can be made of a plastic or paper-like material.

The application and operation of the device is shown in FIG. 2. FIG. 2a shows the underside of the device, including the void patterns on the top and bottom adhesive portions. The adhesive top portion should be applied to the container first because its position is known and fixed, i.e. it is placed near the center of the round container cap or lid. Containers typically have a screw-style cap or a plug-style cap. The adhesive rectangular portion should not be applied to the container first because if it is placed too low on the side of the container then there will be insufficient length for the circular top portion to reach the container lid. Once the circular top portion is in place, the adhesive rectangular portion is placed on the side of the container, such that minimal slack is left in the bridge portion.

FIG. 2b shows the device applied to a beverage container lid. If rectangular portion is placed too high on the container (i.e. too close to the circular portion on the container cap) then there will be a large degree of slack in the bridge portion. This should be avoided because if there is too much slack in the bridge portion then it is possible that the container cap could be removed without disturbing the contact between the adhesive rectangular or circular portions and the container surfaces. Once the device is in place, the container cap cannot be removed, whether a screw-style cap or a plug-style cap, without partially or completely breaking the contact between one or both of the adhesive portions of the device and the container. Alternatively, the removal of the cap could cause breakage of the bridge portion of the device. In either case, tampering will be readily evident. Once contact between an adhesive portion and the container is broken, the void pattern on the broken adhesive portion will be damaged in the region where the seal is broken, and the tampering will be readily evident as shown in FIG. 2c. Moreover, the rectangular and circular adhesive portions will become physically deformed if an attempt is made to peel them from the container surface. This also makes tampering evident.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A device for securing a container from tampering, comprising:
a top portion having an adhesive surface and configured to be applied to the cap of a container, wherein a pattern is embedded in the adhesive surface;
an elongated bridge portion;
a bottom portion having an adhesive surface and configured to be applied to the side of the container, wherein a pattern is embedded in the adhesive surface;
wherein the elongated bridge portion connects the top portion to the bottom portion;
wherein the elongated bridge portion has a width that is less than the width of the top to portion and bottom portion; and
wherein a pattern is embedded in the adhesive surface of the top and bottom portions.

2. The device of claim 1 wherein the top portion is circular.

3. The device of claim 1 wherein the bottom portion is rectangular.

4. The device of claim 1 wherein the elongated bridge portion has a width that is less than the width of both the top portion and bottom portion.

5. The device of claim 1, wherein the container cap cannot be removed from the container without one or more of the following occurring: breaking the bond between the top portion and the container, breaking the bond between the bottom portion and the container, and breaking the elongated bridge portion.

6. The device of claim 1 wherein the pattern embedded in the adhesive surfaces is visibly damaged where the bond between the top or bottom portion and the container is broken.

7. The device of claim 1, wherein the device is made of plastic or paper.
